(19) United States
(12) Patent Application Publication
(10) Pub. No.: US 2024/0022930 A1
(43) Pub. Date: Jan. 18, 2024

(54) THROUGHPUT ESTIMATION SYSTEM, THROUGHPUT ESTIMATION METHOD, AND THROUGHPUT ESTIMATION DEVICE

(71) Applicant: PANASONIC HOLDINGS CORPORATION, Osaka (JP)

(72) Inventors: Akihiro TATSUTA, Kyoto (JP); Yasunori SHIMAZAKI, Fukuoka (JP); Teppei EMURA, Osaka (JP); Takuya ASADA, Tokyo (JP); Taichi HAMABE, Osaka (JP)

(21) Appl. No.: 18/043,684

(22) PCT Filed: Jul. 30, 2021
(86) PCT No.: PCT/JP2021/028519

§ 371 Date: Mar. 1, 2023

(30) Foreign Application Priority Data
Sep. 2, 2020 (JP) 2020-147774

(51) Int. Cl. H04W 24/06; H04W 24/10

(52) U.S. Cl. CPC H04W 24/06; H04W 24/10; H04W 84/12

(57) ABSTRACT

A throughput estimation system according to the present invention comprises, in a space in which a first communication device that generates a beacon is installed, a radio wave receiver having a plurality of antennas that receive the beacon transmitted from the first communication device, and a processor that processes a reception measurement result from the radio wave receiver. On the basis of beacon reception power received by each of the plurality of antennas and the number of the plurality of antennas that detected the beacon, the processor estimates the throughput between the first communication device and a second communication device assumed to be installed in the vicinity of the site at which the beacon was received within the space.

### TECHNICAL FIELD

The present disclosure relates to a throughput estimation system, a throughput estimation method, and a throughput estimation device.

### BACKGROUND ART

Non-Patent Literature 1 discloses that, when a high-speed wireless communication network such as the institute of electrical and electronics engineers (IEEE) 802.11n is designed in an office environment, there is a strong correlation between a received signal strength indicator (RSSI) indicating received power of radio waves radiated from an access point by a client PC and an average throughput, and approximation can be performed by a linear function.

### CITATION LIST

### Non-Patent Literature

Non-Patent Literature 1: H. Takeno, et al., “Radio Wave Propagations through Floors in the Adjacent of a High-speed Indoor Wireless Local Area Network Office Environment”, ISAP 2010, pp. 543-546, November, 2010.

### SUMMARY OF INVENTION

### Technical Problem

An object of the present disclosure is to provide a throughput estimation system, a throughput estimation method, and a throughput estimation device that improve a throughput evaluation accuracy of a wireless communication network in an area and efficiently support a station cell design of a radio wave transmitter.

### Solution to Problem

The present disclosure provides a throughput estimation system including: a radio wave receiver including, in a space in which a first communication device configured to generate a beacon is installed, a plurality of antennas configured to receive the beacon transmitted from the first communication device, and a processor configured to process a reception measurement result from the radio wave receiver, in which the processor estimates, based on received power of the beacon received by each of the plurality of antennas and the number of the plurality of antennas for which the beacon is detected, a throughput between the first communication device and a second communication device assumed to be installed in a vicinity of a point at which the beacon is received in the space.

In addition, the present disclosure provides a throughput estimation method executed by a processor, the throughput estimation method including: acquiring, in a space in which a first communication device configured to generate a beacon is installed, a reception measurement result obtained by receiving the beacon transmitted from the first communication device by a radio wave receiver including a plurality of antennas; and estimating, based on received power of the beacon received by each of the plurality of antennas and the number of the plurality of antennas for which the beacon is detected which are included in the reception measurement result, a throughput between the first communication device and a second communication device assumed to be installed in a vicinity of a point at which the beacon is received in the space.

In addition, the present disclosure provides a throughput estimation device including: a processor; and a memory configured to store, in a space in which a first communication device configured to generate a beacon is installed, a reception measurement result obtained by receiving the beacon transmitted from the first communication device by a radio wave receiver including a plurality of antennas, in which the processor estimates, based on received power of the beacon received by each of the plurality of antennas and the number of the plurality of antennas for which the beacon is detected which are included in the reception measurement result read from the memory, a throughput between the first communication device and a second communication device assumed to be installed in a vicinity of a point at which the beacon is received in the space.

### Advantageous Effects of Invention

According to the present disclosure, the throughput evaluation accuracy of the wireless communication network in the area can be improved, and the station cell design of the radio wave transmitter can be efficiently supported.

### BRIEF DESCRIPTION OF DRAWINGS

FIG. 1 is a block diagram showing in detail an example of a system configuration of a throughput estimation system according to a first embodiment;

FIG. 2 is a perspective view showing an example of an appearance of a hexahedral antenna receiver;

FIG. 3 is a diagram showing an example of an arrangement of an access point and the hexahedral antenna receiver;

FIG. 4A is a diagram showing an example of a layout of a dwelling unit in which an access point is disposed;

FIG. 4B is a graph showing an example of a correlation between received power and a throughput;

FIG. 4C is a graph showing an example of a correlation between the number of detection planes of a beacon and a throughput;

FIG. 4D is a graph showing an example of a correlation among the received power, the number of detection planes of the beacon, and the throughput;

FIG. 5 is a flowchart showing an example of an operation procedure of the throughput estimation system according to the first embodiment in time series;

FIG. 6 is a diagram showing an example of a heat map screen indicating a magnitude of an estimation result of the throughput for the dwelling unit shown in FIG. 4A;

FIG. 7 is a diagram showing an example of a heat map screen indicating a magnitude of an estimation result of the throughput for the dwelling unit shown in FIG. 4A; and

FIG. 8 is a diagram showing an example of a heat map screen indicating a magnitude of an estimation result of the throughput for the dwelling unit shown in FIG. 4A.

### DESCRIPTION OF EMBODIMENTS

### Background of Present Disclosure

In a station cell design of a radio wave transmitter (e.g., an access point of a wireless local area network (LAN)) used in a wireless network, radio wave inspection is generally performed in which a radio wave receiver (e.g., a PC) measures received power of radio waves at each point in an area that is a target of wireless communication. In this radio wave inspection, if not only the received power of the radio waves at each point in the area but also a throughput assumed when the radio wave receiver actually uses the wireless network at each point can be evaluated at the same time, it is expected that the radio wave inspection with higher effectiveness can be implemented.

Non-Patent Literature 1 described above discloses that there is a linear correlation between the throughput and the received power. However, when it is assumed that the use of a wireless communication standard corresponding to high-speed multi-input multi-output (MIMO) communication such as IEEE 802.11ac or IEEE 802.11ax will become widespread in the future, the evaluation using only the received power described above in the evaluation of the throughput in the radio wave inspection may be insufficient.

Therefore, examples of a throughput estimation system, a throughput estimation method, and a throughput estimation device that improve a throughput evaluation accuracy of a wireless communication network in an area and efficiently support a station cell design of a radio wave transmitter will be described in the following embodiments.

Hereinafter, embodiments specifically disclosing the throughput estimation system, the throughput estimation method, and the throughput estimation device according to the present disclosure will be described in detail with reference to the drawings as appropriate.

However, an unnecessarily detailed description may be omitted. For example, a detailed description of well-known matters and a redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

In the following first embodiment, a dwelling unit will be described as an example of an area that is a target of a station design of a first communication device (e.g., an access point of a wireless LAN) used in a wireless communication network. The following description is not limited to the dwelling unit as an area that is a target of the station design, and is similarly applicable to an area other than the dwelling unit (e.g., a shopping mall in which a plurality of stores are provided).

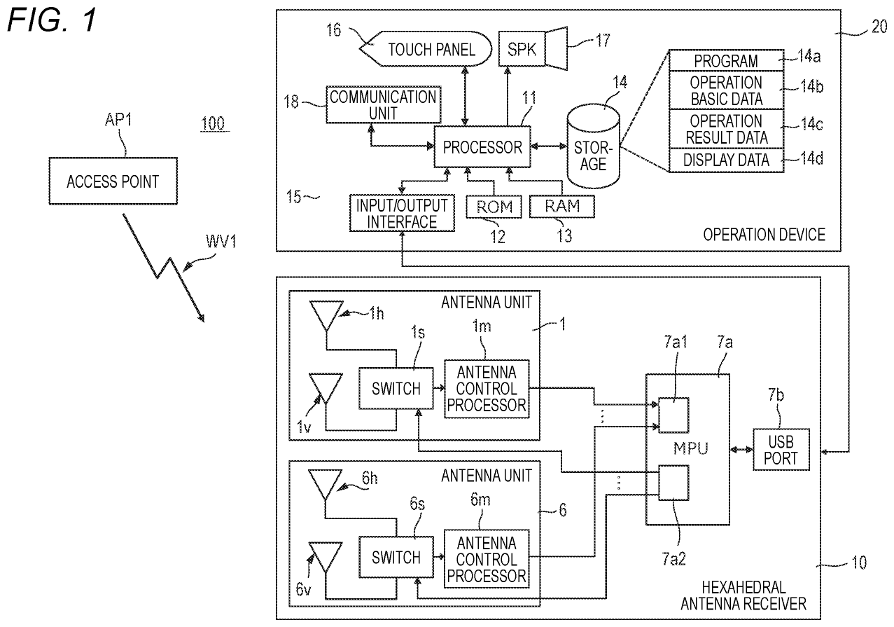

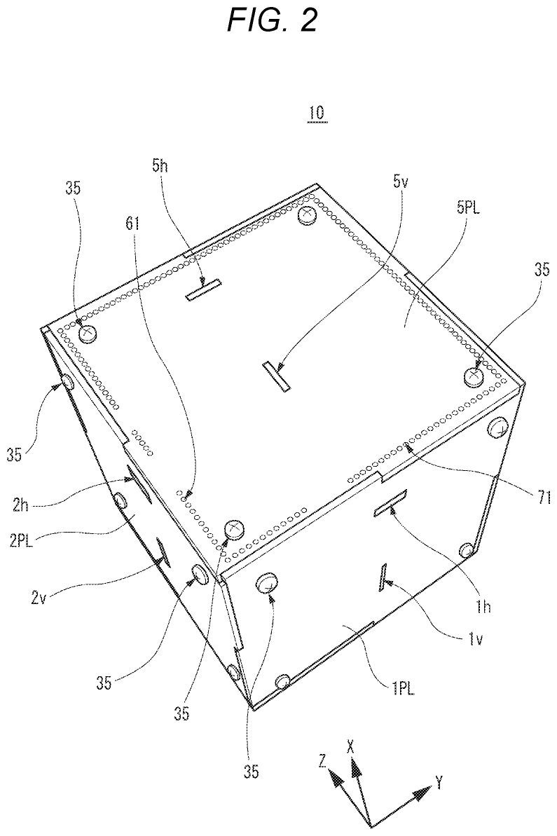

First, an example of a system configuration of a throughput estimation system 100 according to a first embodiment will be described with reference to FIGS. 1 and 2. FIG. 1 is a block diagram showing in detail the example of the system configuration of the throughput estimation system 100 according to the first embodiment. FIG. 2 is a perspective view showing an example of an appearance of a hexahedral antenna receiver 10. As shown in FIG. 1, the throughput estimation system 100 includes at least the hexahedral antenna receiver 10 as an example of a radio wave receiver and an operation device 20. The throughput estimation system 100 may further include an access point AP1 as an example of the first communication device described above.

In the present specification, directions of an X axis, a Y axis, and a Z axis follow the directions of the arrows shown in FIG. 2, respectively. The X-axis direction corresponds to an up-down direction of a housing of the hexahedral antenna receiver 10, the Y-axis direction corresponds to a left-right direction of the housing of the hexahedral antenna receiver 10, and a Z-axis direction corresponds to a front-rear direction of the housing of the hexahedral antenna receiver 10.

The access point AP1 is installed at a location in an inter-space SPC1 of the area that is a target of a station cell design (hereinafter, simply referred to as an “area”). Note that the installation location of the access point AP1 is not fixed, and may be changed as appropriate by a user who is a subject of the station cell design. For example, in a case where the assumed throughput (threshold value) requested by the user cannot be obtained or in a case where the access point AP1 is installed at another location, the access point AP1 may be installed by appropriately changing the installation location.

The access point AP1 generates a radio signal (in other words, a beacon) for detecting the presence of communication devices in conformity with various wireless communication systems for handling a predetermined frequency band (e.g., 1.9 GHz to 2.4 GHz band), modulates the radio signal, and then radiates beacons WV1 (in other words, radio waves) to the inter-space SPC1.

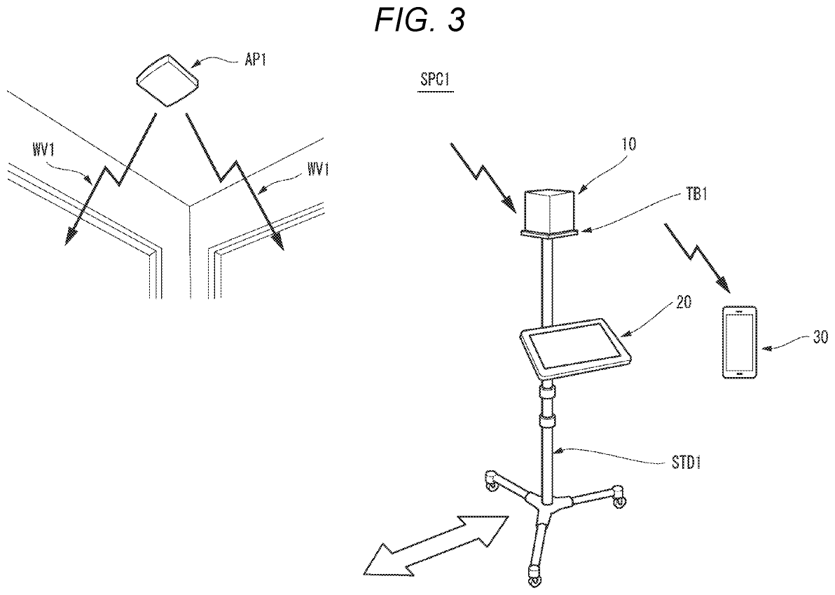

As shown in FIG. 2, the hexahedral antenna receiver 10 includes a housing having a polyhedron (specifically, a hexahedron) such as a quadrangular prism shape (e.g., a rectangular parallelepiped or a cube). Antenna units 1 to 6 (see FIG. 1) respectively correspond to a total of six surfaces (specifically, a front surface 1PL, a left surface 2PL, a rear surface, a right surface, an upper surface 5PL, and a lower surface) constituting the housing. Any surface (e.g., the lower surface) of the housing of the hexahedral antenna receiver 10 is placed on a resin table TB1 which is a material relatively transmitting radio waves (see FIG. 3). Accordingly, the hexahedral antenna receiver 10 can receive the beacons WV1 (see FIG. 1) propagating through the inter-space SPC1 in the area by using the antenna units 1 to 6 provided on all of the six surfaces.

As shown in FIG. 1, the hexahedral antenna receiver 10 includes antenna units 1 to 6, an MPU 7a, and a universal serial bus (USB) port 7b. The configurations of the antenna units 1 to 6 are the same (common), and the antenna unit 1 will be described as an example to simplify the description. In addition, the following description of the antenna unit 1 may be replaced as a corresponding configuration of another antenna unit.

The antenna unit 1 includes a horizontal polarization antenna 1h, a vertical polarization antenna 1v, a switch 1s, and an antenna control processor 1m.

The horizontal polarization antenna 1h receives horizontally polarized waves of beacons from various signal sources (not shown), which include the beacons WV1 (that is, the beacons WV1 radiated from the access point AP1) propagating through the inter-space SPC1 (see FIG. 3) in the area. Specifically, the horizontal polarization antenna 1h receives horizontally polarized waves in a predetermined frequency band (e.g., a band of 1.9 GHz to 2.4 GHz). The frequency band of the horizontally polarized waves that can be received by the horizontal polarization antenna 1h is not limited to 1.9 GHz to 2.4 GHz, and may be, for example, a 920 MHz band or a 5.0 GHz band. The horizontal polarization antenna 1h is electrically connected to the switch 1s.

The vertical polarization antenna 1v receives vertically polarized waves of beacons from various signal sources (not shown), which include the beacons WV1 (that is, the beacons WV1 radiated from the access point AP1) propagating through the inter-space SPC1 (see FIG. 3) in the area. Specifically, the vertical polarization antenna 1v receives vertically polarized waves in a predetermined frequency band (e.g., a band of 1.9 GHz to 2.4 GHz). The frequency band of the vertically polarized waves that can be received by the vertical polarization antenna 1v is not limited to 1.9 GHz to 2.4 GHz, and may be, for example, a 920 MHz band or a 5.0 GHz band. The vertical polarization antenna 1v is electrically connected to the switch 1s.

The switch is connects the horizontal polarization antenna 1h or the vertical polarization antenna 1v to the antenna control processor 1m in response to a switch switching signal output in a time division manner from a switch switching control processor 7a2 of the MPU 7a to the surfaces constituting the housing of the hexahedral antenna receiver 10. In other words, the switch is outputs an output of the horizontal polarization antenna 1h or the vertical polarization antenna 1v to the antenna control processor 1m in response to the above-described switch switching signal. The switch is also has a function of outputting, to the outside, a radio wave signal received by the horizontal polarization antenna 1h or the vertical polarization antenna 1v. For example, the antenna unit 1 may also output a signal to a measurement device (not shown, for example, a spectrum analyzer or a network analyzer) via the switch 1s. The measurement device (see the above description) that receives the radio wave signal may output a result of performing a predetermined process on the radio wave signal to the hexahedral antenna receiver 10 via a USB port 7b. In addition, the hexahedral antenna receiver 10 may output, via another USB port 7b, the radio wave signal processed by the measurement device (see the above description) to the operation device 20 connected thereto. In this way, a preprocess of the radio wave signal itself, removal of a mixed noise, and the like can be performed before the operation process. Therefore, the throughput can be estimated with a higher accuracy.

The antenna control processor 1m is implemented by using a circuit that can process a radio signal in conformity with various wireless communication systems for handling the predetermined frequency band (see the above description). The wireless communication system referred to here is, for example, a wireless LAN such as digital enhanced cordless telecommunications (DECT), Bluetooth (registered trademark), or Wi-Fi (registered trademark). The antenna control processor 1m extracts an output (e.g., an intensity of received power or a received electric field) of the horizontal polarization antenna 1h or the vertical polarization antenna 1v connected to the switch is as parallel data, and outputs the parallel data to a data conversion processor 7a1 of the MPU 7a.

The MPU (micro processing unit) 7a functions as a control unit of the hexahedral antenna receiver 10, and performs a control process for controlling an overall operation of the units of the hexahedral antenna receiver 10, an input/output process of data between the units of the hexahedral antenna receiver 10, an operation process of data, and a storage process of data. The MPU 7a includes the data conversion processor 7a1 and the switch switching control processor 7a2.

When a measurement command for measuring the received power of the beacons WV1 from the access point AP1 is sent from the operation device 20, the MPU 7a receives the measurement command via the USB port 7b. The MPU 7a shifts to a reception measurement mode in response to the reception of the measurement command, and controls the units of the hexahedral antenna receiver 10 so as to start the measurement of the received power of the beacons WV1 from the access point AP1. For example, in the reception measurement mode, the MPU 7a controls the antenna units 1 to 6 so as to receive and detect the beacons WV1 by using antennas (specifically, a horizontal polarization antenna and a vertical polarization antenna) respectively disposed on each of the six surfaces. As described above, the hexahedral antenna receiver 10 can receive and detect the reception measurement mode (that is, the beacons WV1 from the access point AP1) in accordance with the measurement command sent from the operation device 20.

The data conversion processor 7a1 is implemented using, for example, a universal asynchronous receiver/transmitter (UART) circuit, and converts parallel data output from each of the antenna control processors (e.g., the antenna control processors 1m to 6m) into serial data. This data (e.g., the received power or the intensity of the received electric field of beacons transmitted from various signal sources including the access point AP1) is input to the operation device 20 via the USB port 7b.

The switch switching control processor 7a2 generates, in a time division manner, a switch switching signal for inputting the output of the horizontal polarization antenna or the vertical polarization antenna of any one of the surfaces of the hexahedral antenna receiver 10 to the MPU 7a. The switch switching control processor 7a2 includes a general-purpose input/output (GPIO) terminal, and outputs the above-described switch switching signal to the switches (e.g., the switches is to 6s) on the respective surfaces via the GPIO terminal. Accordingly, by the switch switching signal, only an output value of any one of the 12 antennas of the hexahedral antenna receiver 10 can be exclusively input to the MPU 7a periodically in an order of an output of the horizontal polarization antenna 1h of the antenna unit 1, an output of the vertical polarization antenna 1v of the antenna unit 1, . . . , an output of a horizontal polarization antenna 6h of the antenna unit 6, and an output of a vertical polarization antenna 6v of the antenna unit 6 at every predetermined time, and only an output value of any one of the antennas can be exclusively input to the MPU 7a.

The USB port 7b connects the hexahedral antenna receiver 10 and the operation device 20.

It should be noted that although the above description exemplifies a case where the hexahedral antenna receiver 10 receives a beacon, it may be considered that the hexahedral antenna receiver 10 has a configuration for transmitting a beacon. That is, the hexahedral antenna receiver 10 may switch so as to use any one of the antenna units 1 to 6 in a time division manner, and may further transmit a beacon in a time division manner from a horizontal polarization antenna or a vertical polarization antenna provided in the antenna unit.

The hexahedral antenna receiver 10 includes, as main components, a laminated substrate as a surface material constituting each surface, and a frame body inside the housing of the hexahedral antenna receiver 10. The laminated substrate and the frame body constitute the housing of the hexahedral antenna receiver 10, which is a polyhedron (e.g., a hexahedron). The housing of the hexahedral antenna receiver 10 is, for example, a hexahedron, and FIG. 2 illustrates a case where the housing is a cube. The laminated substrate is attached to each surface of the cube by, for example, fixing screws 35.

The surface material constituting the housing of the hexahedral antenna receiver 10 is not limited to the laminated substrate. The polyhedron is not limited to a hexahedron, and may be, for example, a tetrahedron and a dodecahedron. In addition, the hexahedral antenna receiver 10 may have a prismatic shape instead of a hexahedron, and may have any shape as long as it is a three-dimensional shape having a plurality of surfaces.

In the hexahedral antenna receiver 10, antennas (a horizontal polarization antenna and a vertical polarization antenna) are respectively provided on a laminated substrate disposed on one upper surface 5PL, laminated substrates respectively disposed on four side surfaces (e.g., the front surface 1PL, the left surface 2PL, a right surface, and a rear surface), and a laminated substrate disposed on one lower surface. Accordingly, the hexahedral antenna receiver 10 can receive incoming beacons from a total of six directions. When the hexahedral antenna receiver 10 is fixed to a predetermined mounting surface and a beacon is measured, a laminated substrate having an antenna may be omitted on the lower surface of the hexahedral antenna receiver 10.

The antenna disposed in each of the laminated substrates is, for example, a dipole antenna. The dipole antenna is formed on, for example, a laminated substrate, and a pattern of the dipole antenna is formed by etching a metal foil on a surface of the dipole antenna. Each of the plurality of layers is made of, for example, copper foil, or glass epoxy.

For example, horizontal polarization antennas 1h to 6h in the band of 1.9 GHz to 2.4 GHz and vertical polarization antennas 1v to 6v in the band of 1.9 GHz to 2.4 GHz are provided on a surface (upper layer) of each of the laminated substrates of the cubic housing of the hexahedral antenna receiver 10.

An artificial magnetic conductor (AMC) is used to form a laminated substrate. The AMC is an artificial magnetic conductor having perfect magnetic conductor (PMC) characteristics, and is formed by a predetermined metal pattern. By using the AMC, the antennas of the hexahedral antenna receiver 10 can be disposed parallel to the respective laminated substrates, and the overall size can be reduced. In addition, the AMC can be prevented from receiving beacons from other directions by the ground conductor, and the gain of the antenna can be increased.

In the hexahedral antenna receiver 10, a plurality of grounding via conductors 61 are linearly arranged along each side on edges of four sides of the laminated substrate. The grounding via conductors 61 may be disposed at equal intervals. In addition, the grounding via conductors 61 may be provided with sufficient pitches (intervals) to the extent that a beacon from the outside of the hexahedral antenna receiver 10 can be shielded in accordance with a frequency band (in other words, a wavelength) corresponding to the antenna conductor disposed on the laminated substrate. The grounding via conductor 61 penetrates from an upper surface to a lower surface of the laminated substrate.

In the hexahedral antenna receiver 10, a laminated substrate is formed in, for example, a quadrangular shape. In the laminated substrate, a protruding portion and a recessed portion are formed in each side portion in a direction along the side portion with one step portion 71 provided in a center of the side portion as a boundary. That is, as shown in FIG. 2, the housing of the hexahedral antenna receiver 10 is combined by fitting a recessed portion and a protruding portion between adjacent laminated substrates.

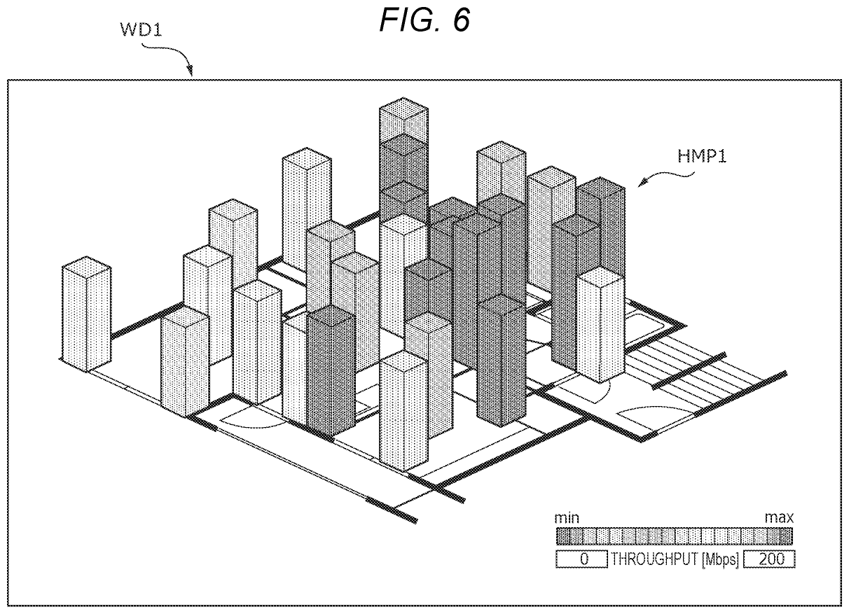

The operation device 20 is connected to the hexahedral antenna receiver 10 via a wired cable (e.g., a USB cable), and receives data of a reception measurement result indicating a radio wave intensity (e.g., an intensity of a received power or a received electric field) of a beacon received by the hexahedral antenna receiver 10. The operation device 20 performs estimation, by using the received radio wave intensity of the beacon, for each point at which a communication terminal 30 (an example of a second communication device) installed in the area is located. In addition, the operation device 20 determines (infers), by comparing the estimation results of the throughput or the like, at which location in the inter-space SPC1 of the area an access point is to be installed. The operation device 20 generates a communication environment in the area (e.g., a heat map indicating the magnitude of the throughput for each position of the communication terminal 30) based on the estimation result of the throughput for each point at which the communication terminal 30 is located, and displays the communication environment on a touch panel 16 (see FIGS. 6, 7, and 8).

The operation device 20 as an example of a throughput estimation device includes a processor 11, a ROM 12, a RAM 13, a storage 14, an input/output interface 15, the touch panel 16, a speaker 17, and a communication unit 18. The ROM 12, the RAM 13, the storage 14, the input/output interface 15, the touch panel 16, the speaker 17, and the communication unit 18 are connected to the processor 11 by an internal bus or the like so as to input or output data or information.

The processor 11 is implemented using, for example, a central processing unit (CPU), a digital signal processor (DSP), or a field programmable gate array (FPGA). The processor 11 functions as a control unit of the operation device 20, and performs a control process for controlling an overall operation of the units of the operation device 20, an input/output process of data or information between the units of the operation device 20, an operation process of data, and a storage process of data or information. The processor 11 operates in accordance with a program 14a stored in the storage 14. The processor 11 uses the ROM 12 and the RAM 13 during execution of the process, and outputs operation result data 14c generated by the operation process described later or display data 14d based on the operation result data 14c to the touch panel 16 to display the operation result data 14c or the display data 14d.

The processor 11 estimates the throughput between the access point AP1 installed in the area and the communication terminal 30 (see FIG. 3) assumed to be installed in a vicinity of a point at which the beacons WV1 are received in the inter-space SPC1 of the area, for each point at which the communication terminal 30 is located, by using the radio wave intensity of the beacon received from the hexahedral antenna receiver 10. Further, the processor 11 determines (infers), by comparing the estimation results of the throughput or the like, at which location in the inter-space SPC1 of the area an access point is to be installed. In addition, the processor 11 generates a communication environment in the area (e.g., a heat map indicating the magnitude of the throughput for each position of the communication terminal 30) based on the estimation result of the throughput for each point at which the communication terminal 30 is located, and displays the communication environment on the touch panel 16 (see FIGS. 6, 7, and 8).

The ROM 12 is a read-only memory, and stores programs and data of an operating system (OS) in advance. The program in the OS is executed when the operation device 20 is activated.

The RAM 13 is a writable and readable memory and is used as a work memory during execution of an estimation process of a throughput, an inference process of an installation location of an access point, or a generation process of a heat map. The RAM 13 temporarily holds data or information used or generated during the estimation process of a throughput, the inference process of an installation location of an access point, or the generation process of a heat map.

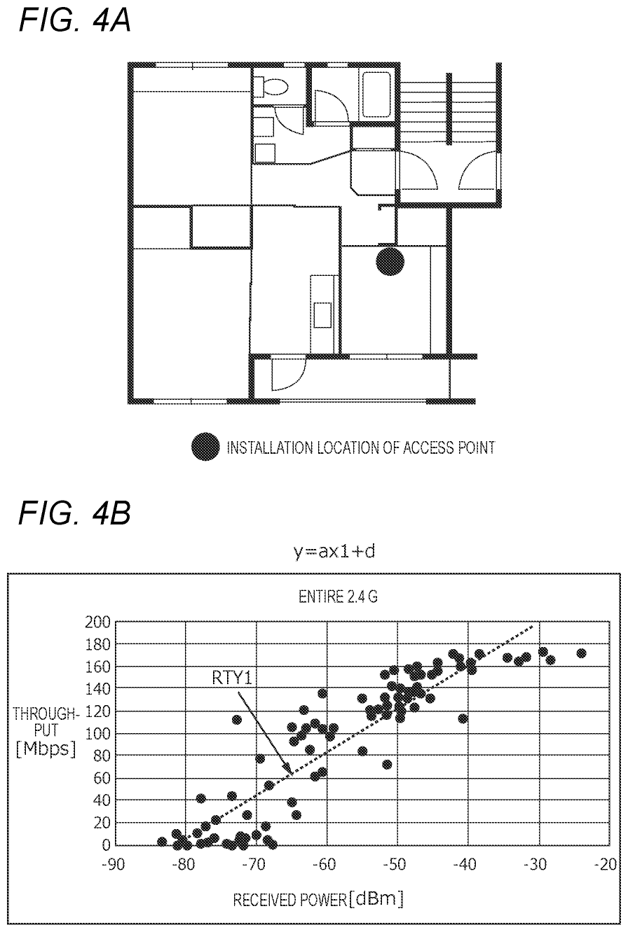

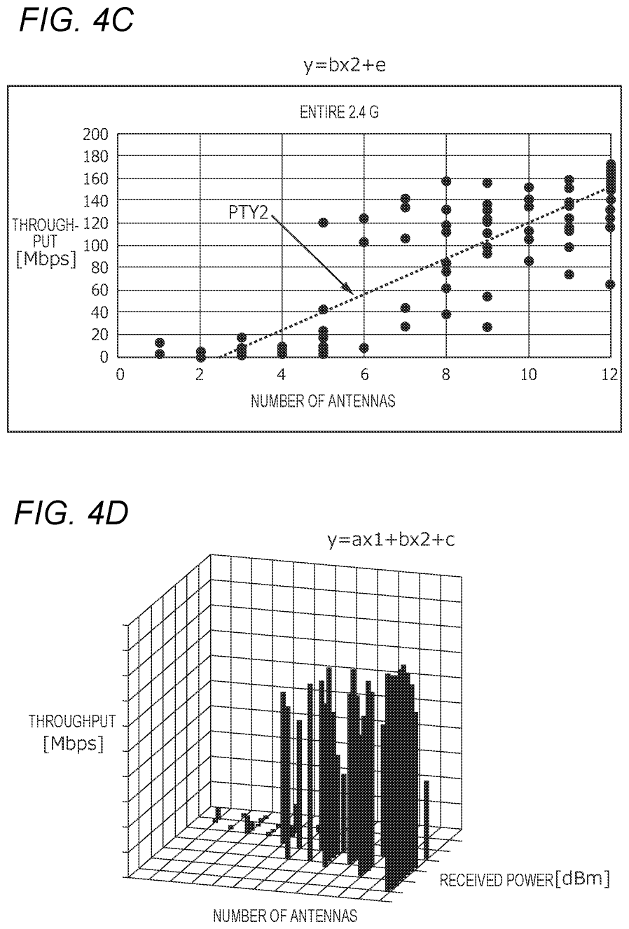

The storage 14 stores the program 14a for executing the estimation process of a throughput, the inference process of an installation location of an access point, or the generation process of a heat map, operation basic data 14b used for the estimation process of a throughput, the inference process of an installation location of an access point, or the generation process of a heat map, the operation result data 14c corresponding to results of the estimation process of a throughput, the inference process of an installation location of an access point, or the generation process of a heat map, and the display data 14d generated based on the operation result data 14c. The operation basic data 14b includes, for example, information of a mathematical expression or a table during the execution of the estimation process of a throughput, the inference process of an installation location of an access point, or the generation process of a heat map, data of a layout in an area (e.g., see FIG. 4A), data of the reception measurement result (see the above description) from the hexahedral antenna receiver 10 input via the input/output interface 15, and information on the access point AP1.

The program 14a for executing the estimation process of a throughput, the inference process of an installation location of an access point, or the generation process of a heat map is read from the storage 14 to the RAM 13 via the processor 11, and is executed by the processor 11. In addition, the program 14a may be recorded in a recording medium (not shown, e.g., a CD-ROM) other than the storage 14, and may be read into the RAM 13 by a corresponding reading device (not shown, e.g., a CD-ROM drive device).

The input/output interface 15 operates as an interface for inputting or outputting data or information between the input/output interface 15 and the hexahedral antenna receiver 10. The input/output interface 15 receives the reception measurement result of the beacons WV1 radiated from the access point AP1 from the hexahedral antenna receiver 10 and transmits the reception measurement result to the processor 11. In FIG. 1, the interface is abbreviated as “I/F” for convenience.

The touch panel 16 has a function as a human interface with a user, and inputs an operation of the user. In other words, the touch panel 16 is used for various settings in various processes executed by the operation device 20. The touch panel 16 may be implemented by using a display device such as a liquid crystal display (LCD) or an organic electroluminescence (EL), and displays the contents of various settings, the operation state of the operation device 20, various operation results, and the display data 14d corresponding to the operation results.

For example, when the processor 11 determines that a period of the reception measurement mode (see the above description) has elapsed, the speaker 17 outputs, based on an instruction from the processor 11, a sound indicating that the reception measurement mode has ended. In addition, for example, when the processor 11 determines that the period of the reception measurement mode (see the above description) has started, the speaker 17 may output, based on an instruction from the processor 11, a sound indicating that the reception measurement mode has started.

The communication unit 18 is implemented by using a communication circuit for performing wired or wireless communication with a measurement device (e.g., a spectrum analyzer or a network analyzer) not shown in FIG. 1. Also, the communication unit 18 may perform wired or wireless communication with a communication device (not shown) other than the measurement device described above.

FIG. 3 is a diagram showing an example of an arrangement of the access point AP1 and the hexahedral antenna receiver 10. For example, the access point AP1 is disposed in a manner of abutting against the inter-space SPC1 in the area (e.g., a ceiling surface of a dwelling unit). Note that the access point AP1 may be installed not only on the ceiling surface but also on a wall surface. When the power is turned on, the access point AP1 generates and radiates a radio signal (e.g., beacons WV1) corresponding to a wireless communication system (e.g., a wireless LAN system based on IEEE 802.11ac, or IEEE 802.11ax) requested by the user.

During the period of the reception measurement mode, the hexahedral antenna receiver 10 is disposed on the resin table TB1 provided at a top of a tripod stand STD1 having casters attached to a bottom thereof. The tripod stand STD1 can be easily moved by the user. The hexahedral antenna receiver 10 is disposed on the resin table TB1, so that it is possible to prevent inhibition of reception of the beacons WV1 on a surface of the hexahedral antenna receiver 10 that is in contact with the table TB1 (e.g., a lower surface facing the upper surface 5PL in FIG. 2).

As shown in FIG. 3, the operation device 20 may be disposed in a manner of being hung on a mounting table of the tripod stand STD1. FIG. 3 illustrates a state where the hexahedral antenna receiver 10 and the operation device 20 are connected by a USB cable. The operation device 20 estimates the throughput between the access point AP1 and the communication terminal 30 assumed to be installed in the vicinity of the point where the beacons WV1 in the inter-space SPC1 in the area are received, for each point at which the communication terminal 30 is located, by using the data of the reception measurement result of the beacons WV1 measured during the period of the reception measurement mode of the hexahedral antenna receiver 10. Here, since the communication terminal 30 is located in a vicinity of the hexahedral antenna receiver 10, the point at which the communication terminal 30 is located can be said to be the point at which the hexahedral antenna receiver 10 is located.

Next, an experimental example related to the estimation of the throughput will be described with reference to FIGS. 4A to 4D. FIG. 4A is a diagram showing an example of a layout of a dwelling unit RM1 in which the access point AP1 is disposed. FIG. 4B is a graph showing an example of a correlation between received power and a throughput. FIG. 4C is a graph showing an example of a correlation between the number of detection planes of a beacon and a throughput. FIG. 4D is a graph showing an example of a correlation among the received power, the number of detection planes of the beacon, and the throughput.

FIG. 4A shows only the layout of the dwelling unit RM1 in which the access point AP1 is disposed, and in this experiment, the access points AP1 are sequentially disposed at a total of four points including other dwelling units (e.g., two dwelling units) having the same layout as that of the dwelling unit RM1 and a road around a building of the dwelling unit, and the beacon WV1 is radiated at each point. The dwelling unit RM1 is made of 3DK reinforced concrete and has a size of 44 to 49 square meters. The access point AP1 is disposed, for example, in a Japanese room (3) in the dwelling unit RM1. The hexahedral antenna receiver 10 receives and detects the beacon WV1 during the period of the reception measurement mode of the beacon WV1 radiated from the access point AP1 installed (temporarily installed) at each point. When the reception measurement mode is ended, the data of the reception measurement result is input to the operation device 20. Similarly, the reception measurement of the beacon WV1 performed by the hexahedral antenna receiver 10 was executed at each of the remaining three points, and the data of the reception measurement results at the four points in total was accumulated in the operation device 20.

The processor 11 of the operation device 20 may estimate, by using the data of the reception measurement results at the total of four points, the throughput between the access point AP1 and the communication terminal 30 assumed to be installed in the vicinity of the point at which the beacon WV1 is received by using the reception power when the antenna units (specifically, a set of the horizontal polarization antenna and the vertical polarization antenna) provided on each of the six surfaces of the hexahedral antenna receiver 10 receive the beacon WV1 (see FIG. 4B). The horizontal axis in FIG. 4B indicates the received power [dBm], and the vertical axis in FIG. 4B indicates the throughput [Mbps]. The processor 11 of the operation device 20 calculates a slope a of the approximation formula in FIG. 4B by approximating a throughput characteristic PTY1 relative to the received power with, for example, a linear function (straight line) (y=ax1+d). Here, y represents the throughput, x1 represents the received power, and a represents the slope of the approximate formula in FIG. 4B.

In addition, the processor 11 of the operation device 20 may determine, by using the data of the reception measurement results at each of the four points in total, the number of antennas for which each of the six antenna units (specifically, the set of the horizontal polarization antenna and the vertical polarization antenna) of the hexahedral antenna receiver 10 detects the reception of the beacon WV1. For example, the processor 11 of the operation device 20 determines the above number of antennas by reading, from the operation basic data 14b of the storage 14, a threshold value of the received power when the reception of the beacon WV1 is detected, and comparing the received power and the threshold value. The processor 11 of the operation device 20 estimates, by using the determination result of the number of antennas, the throughput between the access point AP1 and the communication terminal 30 assumed to be installed in the vicinity of the point at which the beacon WV1 is received (see FIG. 4C). The horizontal axis in FIG. 4C indicates the number of antennas for which reception of the beacon WV1 is detected, and the vertical axis in FIG. 4C indicates a throughput [Mbps]. The processor 11 of the operation device 20 calculates a slope b of the approximate formula of FIG. 4C by approximating, with, for example, a linear function (straight line) (y=bx2+e), a throughput characteristic PTY2 relative to the number of antennas for which reception of the beacon WV1 is detected. Here, y represents the throughput, x2 represents the number of detection planes of the beacon, and b represents the slope of the approximate formula in FIG. 4C.

The processor 11 of the operation device 20 estimates the throughput relative to the received power and the number of antennas by a multiple regression analysis using the received power and the number of antennas for which the reception of the beacon WV1 is detected (in other words, the slopes a and b of the respective approximate formulas in FIGS. 4B and 4C) (see FIG. 4D). The processor 11 of the operation device 20 does not necessarily execute each of a single regression analysis for analyzing the throughput relative to the received power and a single regression analysis for analyzing the throughput relative to the number of antennas, and may substantially estimate the throughput by one multiple regression analysis using the received power and the number of antennas. In FIG. 4D, an axis of the throughput is set relative to an axis of the received power and an axis of the number of antennas. Specifically, the processor 11 of the operation device 20 estimates the throughput between the access point AP1 and the communication terminal 30 (see FIG. 3) assumed to be installed in the vicinity of the point at which the beacon WV1 is received, according to an approximate formula (y=ax1+bx2+c) using the slopes a and b (constants) of the approximate formula, the received power x1 (variable), and the number x2 (variable) of antennas for which the reception of the beacon WV1 is detected. Accordingly, the estimation accuracy of the throughput is improved as compared with the throughput estimation using only the measured values of the received power in Non-Patent Literature 1.

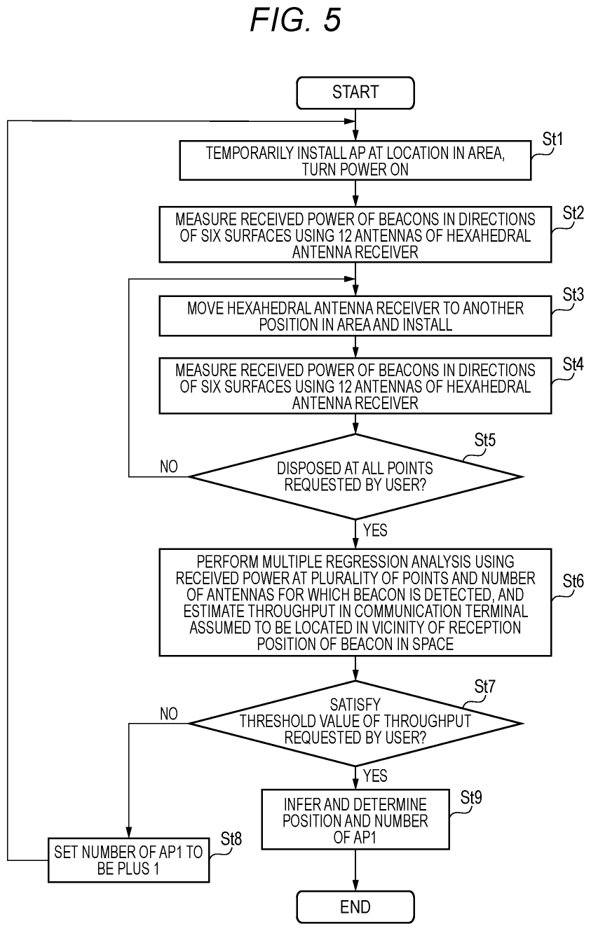

Next, an example of an operation procedure of the throughput estimation system 100 according to the first embodiment will be described with reference to FIG. 5. FIG. 5 is a flowchart showing an example of an operation procedure of the throughput estimation system 100 according to the first embodiment in time series. At each point, in addition to the received power and the number of antennas for which the reception of the beacon WV1 is detected, the actually measured value of the throughput necessary for the multiple regression analysis is measured at several points among the points at which the measurement is performed. In the following steps, among the measurement points, the estimated value of the throughput, which is to be processed, may be replaced with the actually measured value at a point at which both the estimated value and the actually measured value of the throughput exist.

In FIG. 5, the user temporarily installs the access point AP1 at a location in the area (e.g., see the Japanese room (3) of the dwelling unit RM1 in FIG. 4A), and the power is turned on (St1). The location where the access point AP1 is temporarily installed is preferably determined in advance by the user in accordance with the layout (floor plan) of the area. Accordingly, the access point AP1 generates the beacons WV1 and radiates the beacons WV1 to the inter-space SPC1 in the area (see FIG. 3). In addition, the hexahedral antenna receiver 10 is disposed at any point in the area by the movement of the tripod stand STD1 performed by the user.

At the point at which the hexahedral antenna receiver 10 is disposed, the hexahedral antenna receiver 10 receives, by using the antenna units (specifically, a set of a horizontal polarization antenna and a vertical polarization antenna) provided on each of the six surfaces, the beacons WV1 radiated from the access point AP1 (St2). The hexahedral antenna receiver measures the received power when the beacons WV1 are received by the antenna units (see the above description) provided on each of the six surfaces (St2).

After step St2, the hexahedral antenna receiver 10 is disposed at another point in the area by the movement of the tripod stand STD1 performed by the user (St3).

At the point at which the hexahedral antenna receiver 10 is disposed, the hexahedral antenna receiver 10 receives, by using the antenna units (specifically, a set of a horizontal polarization antenna and a vertical polarization antenna) provided on each of the six surfaces, the beacons WV1 radiated from the access point AP1 (St4). The hexahedral antenna receiver measures the received power when the beacons WV1 are received by the antenna units (see the above description) provided on each of the six surfaces (St4).

Here, it is determined whether the hexahedral antenna receiver 10 has been disposed at all points (in other words, reception points) requested by the user (St5). In a case where the hexahedral antenna receiver 10 is not disposed at all points (in other words, reception points) requested by the user (St5, NO), the processes of steps St3 and St4 are repeated until the hexahedral antenna receiver 10 is disposed at all points (in other words, reception points) requested by the user.

On the other hand, in a case where the hexahedral antenna receiver 10 is disposed at all the points (in other words, reception points) requested by the user (St5, YES), the processor 11 of the operation device 20 performs the multiple regression analysis using the received power at the plurality of points and the number of antennas for which the reception of the beacon WV1 is detected, and estimates the throughput in the communication terminal 30 assumed to be located in a vicinity of a reception position of the beacon WV1 in the inter-space SPC1 in the area (St6).

The determination in step St5 may be performed by the user or may be performed by the processor 11 of the operation device 20 as a software process. For example, if the processor 11 acquires position information on the point at which the hexahedral antenna receiver 10 is disposed from an external server or the hexahedral antenna receiver 10 and associates the position information with the data of the reception measurement result, the processor 11 may determine whether the data of the reception measurement result associated with each of the position information of all the points at which the hexahedral antenna receiver 10 is disposed is acquired in advance. In addition, the processor 11 may determine whether the hexahedral antenna receiver 10 has been disposed at all the points (in other words, reception points) requested by the user by receiving, via the communication unit 18, a signal indicating whether the hexahedral antenna receiver 10 has been disposed at all the points (in other words, reception points) requested by the user from a terminal (not shown) operated by the user.

The processor 11 of the operation device 20 determines whether the estimation result of the throughput in step St6 satisfies a threshold value of the throughput requested by the user (e.g., a target value of the minimum throughput required according to the use environment of the communication terminal 30) (St7). Various indices may be used to determine whether the estimation result of the throughput satisfies the threshold value of the throughput requested by the user (e.g., the target value of the minimum throughput required according to the use environment of the communication terminal 30). The following methods may be considered, and examples of the methods include a method of comparing a threshold value with an average value of the estimation results of the throughputs at the respective measurement points, a method of comparing a threshold value with a minimum value of the throughputs at the respective measurement points, and a method of determining whether a ratio of the points at which the throughputs at the respective measurement points exceed the threshold value to all the measurement points exceeds a second threshold value.

In addition, the throughput can be estimated more accurately by performing the determination after changing the threshold value or the estimated value based on a difference between a model number of the actually installed access point and a model number of the access point AP1 used in the measurement (in other words, the station cell design). For example, in the measurement (in other words, the station cell design), in a case where the access point AP1 of the model number having three antennas is used, it is predicted that the actually measured value is 2 to 3 times the estimated value in a case where the access point of the model number having six antennas is actually used. Therefore, the processor 11 may include a database (DB) indicating the access point AP1, the model number, and the number of antennas recorded in the operation device 20 in advance, and may perform a process of multiplying the estimated value or the threshold value by a predetermined multiplying factor with reference to the database. That is, the target value of the minimum throughput required according to the use environment may be changed based on a relationship between the number of antennas in the access point AP1 used for the measurement (in other words, the station cell design) and the number of antennas in the access point actually used.

Therefore, in a case where it is determined that the threshold value is not satisfied (St7, NO), the processor 11 of the operation device 20 sets the number of access points AP1 to be installed in the area to be plus one than the number of the access points currently used (St8). After step St8, the operation of the throughput estimation system 100 returns to step St1, and an installation position of the access point AP1 is changed. In a case where the number of the access points AP1 used is set to plus 1 in step St8, another access point AP1 is temporarily installed in step St1 while the installation position of the access point AP1 that is temporarily installed is not changed or changed.

On the other hand, in a case where the processor 11 of the operation device 20 determines that the estimation result of the throughput in step St6 satisfies the threshold value (see the above description) of the throughput requested by the user (St7, YES), the processor 11 infers and determines the position and the number of access points AP1 to be installed so that the throughput of the entire area is increased (St9). For example, the processor 11 of the operation device 20 introduces, by simulation, an evaluation function of the throughput of the communication terminal 30 in the area using the information on the installation position and the number of access points AP1 as variables and the estimation result of the throughput for each point at which the hexahedral antenna receiver 10 is disposed in step St6, and determines the position and the number of access points AP1 to be installed when the maximum value of the evaluation function is obtained. As another example of the inference, the position and the number of access points AP1 to be installed may be determined as the position and the number of access points AP1 actually disposed in the above-described step.

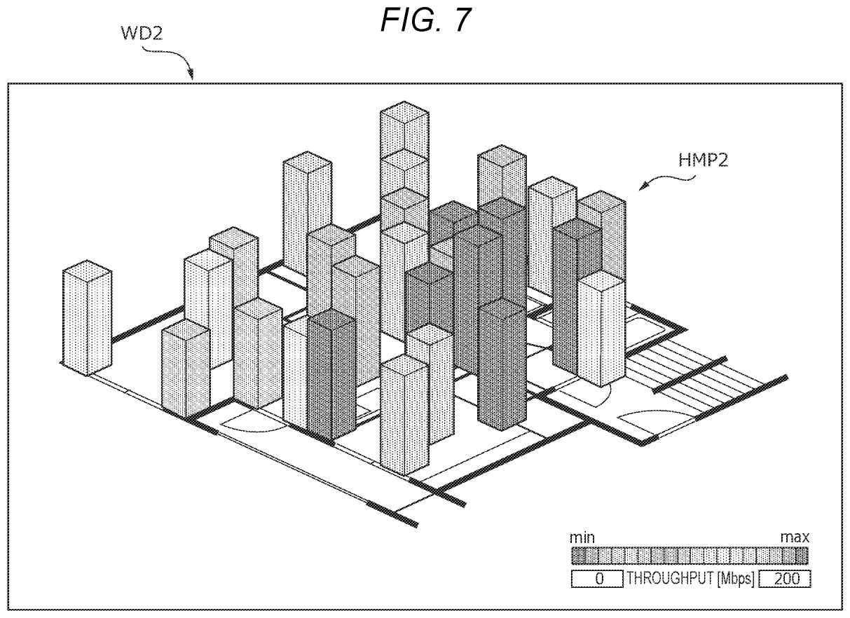

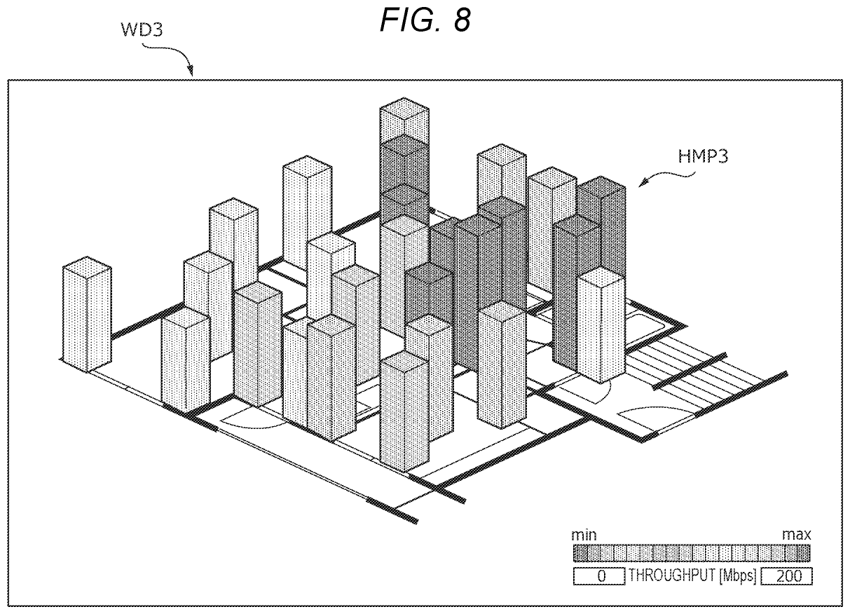

FIG. 6 is a diagram showing an example of a heat map screen indicating a magnitude of an estimation result of the throughput for the dwelling unit shown in FIG. 4A. FIG. 7 is a screen diagram showing an example of a heat map indicating a magnitude of the estimation result of the throughput for the dwelling unit shown in FIG. 4A. FIG. 8 is a screen diagram showing an example of a heat map indicating a magnitude of the estimation result of the throughput for the dwelling unit shown in FIG. 4A. Heat map screens WD1 to WD3 indicating the heat maps HMP1 to HMP3 shown in FIGS. 6 to 8 are displayed on, for example, the touch panel 16 of the operation device 20.

As shown in FIG. 6, the processor 11 of the operation device 20 generates an image of a heat map HMP1 in which a magnitude of a throughput at each point in the dwelling unit RM1 (an example of an area) is visually expressed in color. The shading of each bar constituting the heat map HMP1 indicates the magnitude of the throughput. For example, the heat map HMP1 shown in FIG. 6 visually indicates the magnitude of the throughput estimated based on the received power of both the horizontally polarized wave and the vertically polarized wave received by the antennas (specifically, the horizontal polarization antenna and the vertical polarization antenna) disposed on each of the six surfaces of the hexahedral antenna receiver 10. The processor 11 of the operation device 20 reads, from the operation basic data 14b, image data indicating the layout of the dwelling unit RM1, generates the heat map screen WD1 obtained by superimposing the image of the heat map HMP1 on the image data indicating the layout, and displays the heat map screen WD1 on the touch panel 16.

As shown in FIG. 7, the processor 11 of the operation device 20 generates an image of the heat map HMP2 in which a magnitude of a throughput at each point in the dwelling unit RM1 (an example of an area) is visually expressed in color. The shading of each bar constituting the heat map HMP2 indicates the magnitude of the throughput. For example, the heat map HMP2 shown in FIG. 7 visually indicates the magnitude of the throughput estimated based on the received power of the horizontally polarized wave received by the antenna (specifically, the horizontal polarization antenna) disposed on each of the six surfaces of the hexahedral antenna receiver 10. The processor 11 of the operation device 20 reads, from the operation basic data 14b, image data indicating the layout of the dwelling unit RM1, generates the heat map screen WD2 obtained by superimposing the image of the heat map HMP2 on the image data indicating the layout, and displays the heat map screen WD2 on the touch panel 16.

As shown in FIG. 8, the processor 11 of the operation device 20 generates an image of the heat map HMP3 in which a magnitude of a throughput at each point in the dwelling unit RM1 (an example of an area) is visually expressed in color. The shading of each bar constituting the heat map HMP3 indicates the magnitude of the throughput. For example, the heat map HMP3 shown in FIG. 8 visually indicates the magnitude of the throughput estimated based on the received power of the vertically polarized wave received by the antenna (specifically, the vertical polarization antenna) disposed on each of the six surfaces of the hexahedral antenna receiver 10. The processor 11 of the operation device 20 reads, from the operation basic data 14b, image data indicating the layout of the dwelling unit RM1, generates the heat map screen WD3 obtained by superimposing the image of the heat map HMP3 on the image data indicating the layout, and displays the heat map screen WD3 on the touch panel 16.

As described above, the throughput estimation system 100 according to the first embodiment includes the hexahedral antenna receiver 10 including a plurality of antennas for receiving the beacon WV1 transmitted from the access point AP1 in the inter-space SPC1 in the area where the access point AP1 for generating the beacon WV1 is installed, and the operation device 20 connected to the hexahedral antenna receiver 10. The processor 11 of the operation device 20 estimates the throughput between the access point AP1 and the communication terminal 30 assumed to be installed in the vicinity of the point at which the beacon WV1 is received in the inter-space SPC1, based on the received power of the beacon WV1 received by each of the plurality of antennas and the number of the plurality of antennas (e.g., the number of detection planes of the beacon) for which the beacons WV1 are detected.

Accordingly, the throughput estimation system 100 can estimate, with a high accuracy, the throughput between the access point AP1 and the communication terminal 30 assumed to be installed in the vicinity of the point at which the beacon WV1 is received in the inter-space SPC1 using the data of the reception measurement result of the beacons WV1 received by the hexahedral antenna receiver 10. Therefore, the throughput estimation system 100 can improve the throughput evaluation accuracy of the wireless communication network in the area, and can efficiently support the station cell design of the radio wave transmitter (e.g., the access point AP1).

The hexahedral antenna receiver 10 includes a plurality of antennas (e.g., a horizontal polarization antenna and a vertical polarization antenna) for receiving the beacon WV1, and has a plurality of rectangular surfaces facing two or more different directions. Accordingly, the hexahedral antenna receiver 10 can receive the horizontally polarized and vertically polarized beacons WV1 from multiple directions.

In addition, the hexahedral antenna receiver 10 transmits the data of the reception measurement result for each point of the beacon WV1 when the hexahedral antenna receiver 10 is disposed at each of the plurality of different points in the inter-space SPC1 to the operation device 20 (e.g., the processor 11). The processor 11 of the operation device 20 estimates the throughput corresponding to the data of the reception measurement result for each point of the beacon WV1 for each point at which the hexahedral antenna receiver 10 is disposed. The processor 11 of the operation device 20 causes an image (e.g., an image of a heat map) in a format by which the magnitude of throughput corresponding to at least one point can be identified to be included in an image (e.g., image data indicating a layout of an area) imitating the inter-space SPC1 and displays the image on a monitor (e.g., the touch panel 16). Accordingly, the user who operates the operation device 20 can intuitively and visually grasp what degree of throughput can be obtained in a case where the communication terminal 30 is located at which point in the area in the station cell design of the access point AP1 in the wireless communication network.

In addition, the processor 11 of the operation device 20 infers, based on the estimation result of the throughput corresponding to each point, which point in the space the access point AP1 is to be installed, and outputs the inference result. Accordingly, the user can specifically grasp the location where the access point AP1 is to be installed in the station cell design of the wireless communication network, and thus the work efficiency can be improved.

In addition, the operation device 20 as an example of the throughput estimation device according to the first embodiment includes the processor 11, and a memory (e.g., the storage 14) that stores a reception measurement result obtained by receiving the beacon WV1 transmitted from the access point AP1 in the inter-space SPC1 in which the access point AP1 for generating the beacon is installed by the hexahedral antenna receiver 10 including a plurality of antennas. The processor 11 estimates, based on the received power of the beacon WV1 received by each of the plurality of antennas and the number of the plurality of antennas (e.g., the number of detection planes of the beacon) for which the beacon WV1 is detected which are included in the reception measurement result read from the storage 14, the throughput between the access point AP1 and the communication terminal 30 assumed to be installed in the vicinity of the point at which the beacon WV1 is received in the space SPC1.

Accordingly, the operation device 20 can estimate, with a high accuracy, the throughput between the access point AP1 and the communication terminal 30 assumed to be installed in the vicinity of the point at which the beacon WV1 is received in the space SPC1 using the data of the reception measurement result of the beacon WV1 received by the hexahedral antenna receiver 10. Therefore, the operation device 20 can improve the throughput evaluation accuracy of the wireless communication network in the area, and can efficiently support the station cell design of the radio wave transmitter (e.g., the access point AP1).

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, substitutions, additions, deletions, and equivalents naturally belong to the technical scope of the present disclosure. In addition, the respective constituent elements in the various embodiments described above may be freely combined without departing from the gist of the invention.

The present application is based on Japanese Patent Application No. 2020-147774 filed on Sep. 2, 2020, and the contents thereof are incorporated by reference in the present application.

### INDUSTRIAL APPLICABILITY

The present disclosure is useful as a throughput estimation system, a throughput estimation method, and a throughput estimation device that improve a throughput evaluation accuracy of a wireless communication network in an area and efficiently support a station cell design of a radio wave transmitter.

### REFERENCE SIGNS LIST

1, 6 Antenna unit
1h, 6h Horizontal polarization antenna
1m, 6m Antenna control processor
1s, 6s switch
1v, 6v Vertical polarization antenna
7a MPU
7a1 Data conversion processor
7a2 Switch switching control processor
7b USB Port
10 Hexahedral antenna receiver
11 Processor
12 ROM
13 RAM
14 Storage
15 Input/output interface
16 Touch panel
17 Speaker
20 Operation Device
30 Communication terminal
100 Throughput estimation system

1. A throughput estimation system comprising:
a radio wave receiver including, in a space in which a first communication device configured to generate a beacon is installed, a plurality of antennas configured to receive the beacon transmitted from the first communication device, and
a processor configured to process a reception measurement result from the radio wave receiver,
wherein the processor is configured to estimate, based on received power of the beacon received by each of the plurality of antennas and the number of the plurality of antennas for which the beacon is detected, a throughput between the first communication device and a second communication device assumed to be installed in a vicinity of a point at which the beacon is received in the space.

2. The throughput estimation system according to claim 1,
wherein the radio wave receiver includes a plurality of antennas configured to receive the beacon, and has a plurality of surfaces facing in two or more different directions.

3. The throughput estimation system according to claim 1,
wherein the radio wave receiver sends, to the processor, the reception measurement result of the beacon for each of a plurality of different points in the space, the reception measurement result being obtained when the radio wave receiver is disposed at each of the different points,
the processor is configure to estimate, for each of the points, the throughput corresponding to the reception measurement result of the beacon for each of the points, causes a format by which a magnitude of the throughput corresponding to at least one of the points can be identified to be included in an image imitating the inter-space, and display the image on a monitor.

4. The throughput estimation system according to claim 1,
wherein the processor is configured to infer, based on an estimation result of the throughput corresponding to each of the points, at which point in the space the first communication device is to be installed, and output the inference result.

5. A throughput estimation method executed by a processor, the throughput estimation method comprising:
acquiring, in a space in which a first communication device configured to generate a beacon is installed, a reception measurement result obtained by receiving the beacon transmitted from the first communication device by a radio wave receiver including a plurality of antennas; and
estimating, based on received power of the beacon received by each of the plurality of antennas and the number of the plurality of antennas for which the beacon is detected which are included in the reception measurement result, a throughput between the first communication device and a second communication device assumed to be installed in a vicinity of a point at which the beacon is received in the space.

6. A throughput estimation device comprising:
a processor; and
a memory configured to store, in a space in which a first communication device configured to generate a beacon is installed, a reception measurement result obtained by receiving the beacon transmitted from the first communication device by a radio wave receiver including a plurality of antennas,
wherein the processor is configured to estimate, based on received power of the beacon received by each of the plurality of antennas and the number of the plurality of antennas for which the beacon is detected which are included in the reception measurement result read from the memory, a throughput between the first communication device and a second communication device assumed to be installed in a vicinity of a point at which the beacon is received in the space.
